(19) United States
(12) Patent Application Publication
(10) Pub. No.: US 2009/0218028 A1
(43) Pub. Date: Sep. 3, 2009

(54) ALIGNED SURFACE-ENHANCED RAMAN SCATTERING PARTICLES, COATINGS MADE THEREBY, AND METHODS OF USING SAME

(75) Inventor: Tzu-Yu Wang, Maple Grove, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/040,819

(22) Filed: Feb. 29, 2008

(51) Int. Cl. B29C 65/00; B32B 5/16; G01J 3/44

(52) U.S. Cl. 156/60; 428/323; 356/301

(57) ABSTRACT

A surface-enhance Raman scattering (SERS) film is disposed on a portion of an asymmetrical optical coating of a core. The core has diameter in a range from about 10 nanometer (nm) to about 1,000 nm. The asymmetrical optical coating is in contact with a covering the core. The SERS film, the asymmetrical optical coating, and the core make up a particle. The particle is disposed on a mounting substrate.

### TECHNICAL FIELD

When light is scattered from a molecule, most photons are elastically scattered. The scattered photons may have the same frequency and, therefore, wavelength, as the incident photons. However, a fraction of light (approximately 1 in 10⁷ photons) may be scattered at optical frequencies different from the frequency of the incident photons. The process leading to this inelastic scatter is the termed the Raman effect. Raman scattering can occur with a change in vibrational, rotational or electronic energy of a molecule.

### BRIEF DESCRIPTION OF THE FIGURES

Embodiments of this disclosure are illustrated by way of example and not limitation in the Figures of the accompanying drawings, in which:

FIG. 1 is a cross-section elevation of a coated nanoparticle array during processing according to an example embodiment;

FIG. 2 is an elevational view of a coated particle during processing according to an example embodiment;

FIG. 3 is a side elevation of a mounting substrate during processing according to an example embodiment;

FIG. 4 is a cross-section elevation of a coated particle that is bonding to an array of receptor molecules.

FIG. 5 is a cross-section elevation of the mounting substrate depicted in FIG. 4 after further processing according to an example embodiment;

FIG. 6 is a cross-section elevation of a method of using the mounting substrate depicted in FIG. 5 according to an example embodiment;

FIG. 7 is a method flow diagram according to an example embodiment;

FIG. 8 is a schematic of an engine system 800 that uses a surface-enhanced Raman scattering particle apparatus according to an example embodiment; and

FIG. 9 is a schematic diagram illustrating a medium having an instruction set, according to an example embodiment.

### DETAILED DESCRIPTION

In the following description, numerous specific details are set forth. The following description and the drawing figures illustrate aspects and embodiments sufficiently to enable those skilled in the art. Other embodiments may incorporate structural, logical, electrical, process, and other changes; e.g., functions described as software may be performed in hardware and vice versa. Examples merely typify possible variations and are not limiting. Individual components and functions may be optional, and the sequence of operations may vary or run in parallel. Portions and features of some embodiments may be included in, substituted for, or added to those of others. The scope of the embodied subject matter encompasses the full ambit of the claims and substantially all available equivalents.

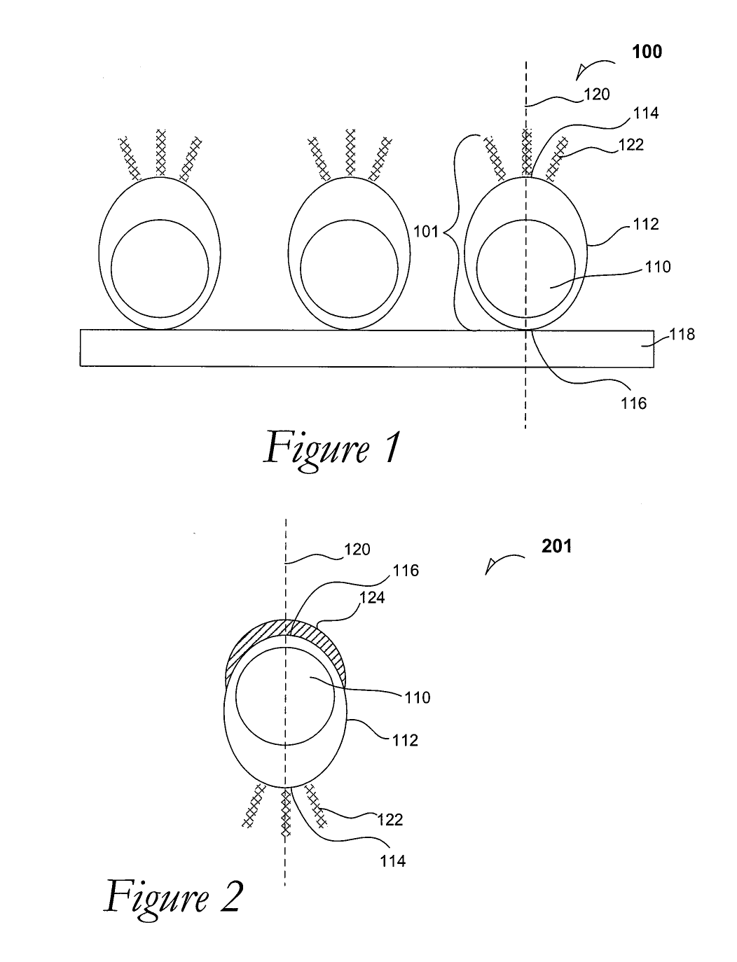

FIG. 1 is a cross-section elevation of a coated nanoparticle array 100 during processing according to an embodiment. FIG. 1 depicts three occurrences of such particles disposed upon the precursor substrate 118, one of which is designated with the reference numeral 101.

The particle 101 is depicted with a particle core 110 that has been asymmetrically coated with a metallic shell 112. In an embodiment, the particle core 110 has a diameter in a range from about 20 nanometer (nm) to about 1,000 nm. The particle core 110 may be a material such as hematite (an iron oxide) that can be obtained from nanoparticulate suppliers. In an embodiment, the particle core 110 is a dielectric material such as a metal oxide.

In an embodiment, the metallic shell 112 may be a metal such as gold that has been formed in contact with and covering the particle core 110. In an embodiment, the metallic shell 112 is a metal such as gold that has been electrolessly plated onto the particle core 110 in a manner to cause the metallic shell 112 to form an assymetrical coating. The metallic shell 112 may also be referred to as an asymmetrical optical coating 112.

The metallic shell 112 may have two locations, which are referred to herein as a shell first location 114 and a shell second location 116. The shell second location 116 is depicted in FIG. 1 as having a thinner skin (distance from the surface of the shell to the center of the particle core 110) than that of the shell first location 114. The distance may be taken from a symmetry line 120 where the metallic shell 112 may be thinnest for the shell second location 116 and thickest for the shell first location 114. In an embodiment, the metallic shell 112 enhances the largest diameter in a range from about 20% to about 60%. This largest diameter is delineated by the symmetry line 120, beginning at the shell first location 114 and ending at the shell second location 116.

The combination of the particle core 110 and the metallic shell 112 may result in light energy being uniquely reflected from the particle 101. Other metals may be used for the metallic shell 112. In an embodiment, the metallic shell 112 is a gold alloy that includes any of the platinum-group metals. In an embodiment, the metallic shell 112 is a platinum-group metal.

A plasmon is a ripple of electron-cloud waves in the “electron sea” that flows constantly across metal surfaces. A plasmon on the surface of the metallic shell 112 can convert light into electrical energy when the frequency of the light resonates with the same frequency for oscillation of the plasmon. This resonant effect can create large local electrical fields that radiate around the particle 101. In an embodiment, the particle 101 at the shell second location 116 may be optically active differently than the particle 101 at the shell first location 114. In an embodiment, the particle 101 at the shell second location 116 may be more optically active than the particle 101 at the shell first location 114.

The particle 101 is depicted disposed upon the precursor substrate 118. In an embodiment, the treatment of the particle 101 has resulted in selected acceptor molecules 122 being located upon the particle 101 at the shell first location 114 where the metallic shell 112 is thicker than at the shell second location 116. In an embodiment, these acceptor molecules 12y 2_acceptor molecules have formed principally at the shell first location 114 due to intermolecular forces such as Van der Waal's forces, the close packing of one particle next to an adjacent particle, and other causes. An example molecule for 122 is a thiol group that will bond with the Au coating and link with a mercaptosilane chemistry 334 attached to the substrate 332.

FIG. 2 is a cross-section elevation of a particle 201 during processing according to an embodiment. In an embodiment, the particle 201 has been removed from a precursor substrate such as the precursor substrate 118 depicted in FIG. 1. The acceptor molecules 122 have caused the shell first location 114 to be a less likely site for allowing bonding of a different molecule and the shell second location 116 to be a more likely site for such bonding. As depicted in FIG. 2, a coating of Raman-active molecules 124 mabe either a Raman active site. In an embodiment, there may be a bond site for Raman active analytes. There may also be a bond site that is Raman active that also has polarization sensitivity to specific analytes according to an embodiment. Further the material is selected according to a useful Raman spectral response when the analyte of interest bonds to the molecule. The Raman-active film 124 is depicted as bonded with the particle at the shell second location 116 where the metallic shell 112 is thinner. In an embodiment, the Raman-active film 124 is formed by selectively treating the asymmetrically coated particle 201. “Selectively treating” means forming the Raman-active film 124 at the shell first location 114 where the shell first location 114 is thinner. This selective treating means the Raman-active film 124 is not formed everywhere over the coated particle 201. Consequently, an anisotropric configuration of the coated particle 201 has occurred with acceptor molecules 122 at the shell first location 114 and Raman-active film 124 at the shell second location 116. The Raman-active film 124 is depicted as a coating that is substantially symmetrically disposed over the particle 201 at the shell second location 116.

In an embodiment, the Raman-active film 124 includes Raman active compositions such as a Raman-active molecule. In an embodiment, the film 134 is a bond site for a Raman active analyte. For example, it is the the material that is to be sensed, or it can be a Raman active material that changes properties when exposed to certain analytes.

Several Raman active molecules may be selected such as bismethylstyrylbenzene (BMSB) according to an embodiment. In an embodiment, naphthalene is used as the Raman-active molecule.

One factor which makes for a useful Raman-active molecule is sufficient coupling between the vibrational mode and polarizability of the molecule. In other words, we want molecules that change their polarization in response to incident light

In an embodiment, the particle 201 is removed from a precursor substrate such as the precursor substrate 118 (FIG. 1) by liquid action such as a liquid wash that frees the particle 201. The wash may be a liquid that is laden with a substance that can form the Raman-active film 124. In an embodiment, the particle 201 is simultaneously removed from a precursor substrate and treated with a substance that results in deposition of the Raman-active film 124 that is in solution or in suspension. The Raman-active film 124 is allowed to attach by the available space of the shell second location 116. In an embodiment, the presence of the acceptor molecules 122 may be sufficient to prevent the Raman-active film 124 from affixing at the shell first location 114 where the metallic shell 112 is thinnest.

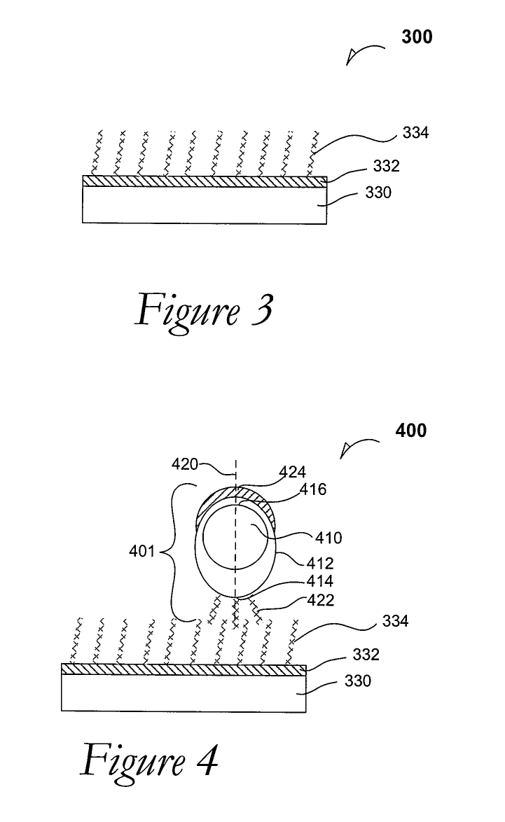

FIG. 3 is a side elevation 300 of a mounting substrate 330 during processing according to an embodiment. In an embodiment, the mounting substrate 330 is an inorganic material such as a ceramic that is capable of withstanding high temperatures such as are found in the exhaust stream of an internal combustion engine. A metallic film 332 is disposed upon the mounting substrate 330 and a film of receptor molecules 334 is formed upon the metallic film 332. The array of active receptor molecules 334 is provided to bond with the acceptor molecules that are attached to the particle embodiments. In an embodiment, the metallic film 332 is treated to form nucleation sites for deposition of the receptor molecules 334. In an embodiment, the nucleation sites are an array of grid-scratch imperfections in the metallic film 332 that allow the receptor molecules 334 to deposit in a pattern.

FIG. 4 is a cross-section elevation 400 of a particle 401 that is bonding to an array of receptor molecules 334 from the mounting substrate 330 depicted in FIG. 3. FIG. 4 depicts the mounting substrate 330 depicted in FIG. 3 after further processing according to an embodiment. The particle 401 may be similar or identical to the coated particle 101 depicted in FIG. 1. The particle 401 is depicted with a particle core 410 and a metallic shell 412. Further, a metallic shell 412 is a metal such as gold that has been electrolessly plated onto a particle core 410 in a manner to cause the metallic shell 412 to form an asymmetrical coating. The metallic shell 412 may have two locations, which are referred to herein as a shell first location 414 and a shell second location 416. The shell second location 416 is depicted in FIG. 4 as having a thinner skin (distance from the surface of the metallic shell to the center of the core 410) than that of the shell first location 414. The distance may be taken from a symmetry line 420 where the metallic shell 412 may be thinnest for the shell second location 416 and thickest for the shell first location 414.

The particle 401 also includes acceptor molecules 422 and a Raman-active film 224 disposed over the particle 401 at the shell second location 416 of the metallic shell 412.

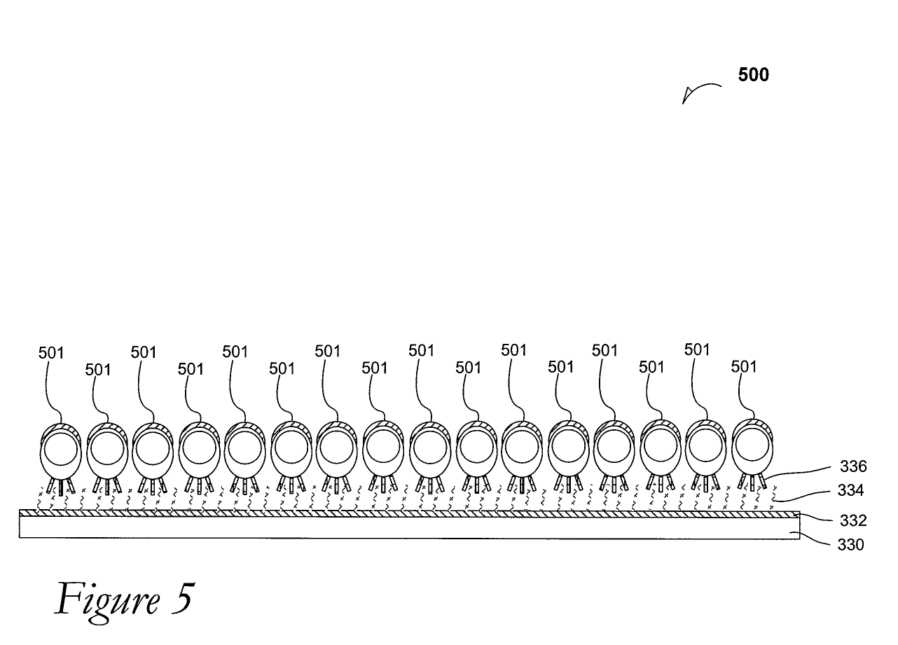

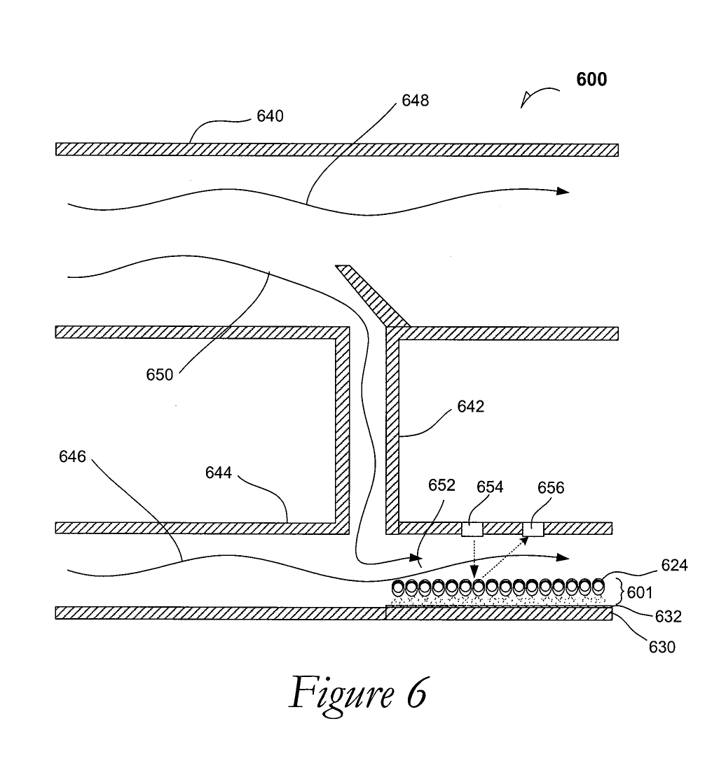

FIG. 5 is a cross-section elevation 500 of a particle array disposed upon a mounting substrate 330 according to an embodiment. A plurality of particles 501, such as the particle 401 depicted in FIG. 4, are disposed upon a mounting substrate such as the mounting substrate 330 depicted in FIG. 3. As the plurality of particles 501 is depicted in cross-section, the plurality of particles 501 exhibit an array configuration that can be manufactured by pretreating the metallic film 332. In an embodiment, the metallic film 332 is treated to form nucleation sites for deposition of the receptor molecules 334. In an embodiment, the nucleation sites are an array of grid-scratch imperfections in the metallic film 332 that allow the receptor molecules 334 to deposit in a pattern

FIG. 6 is a cross-section schematic 600 of a particle array disposed upon a mounting substrate 630 according to an embodiment. The particle array 601 is depicted disposed upon a metallic film 632 that is disposed upon a mounting substrate 630. The particle array 601 includes aligned particles, and a Raman-active film 624 is also depicted. An exhaust corridor 640 is depicted. The exhaust corridor may be an exhaust pipe of an external combustion engine such as a diesel engine. However, the exhaust corridor may be any gas corridor that may carry a gas that is responsive to Raman scattering analysis, according to an embodiment.

The Raman-active film 624 is either a Raman-active material that changes the spectral response based on exposure to analyte materials. Alternatively, there are provided bond bond sites for gas stream analytes of interest that are inherently Raman active. For the embodiment of bond sites, once the gas stream analytes bond to the Raman-active film 624, the sensor is able to sense these analytes due to SERS enhancement. The sensor senses the change in response due to molecular changes in the Raman-active material.

In an embodiment, a gas corridor 642 forms a diversion from the main flow direction made possible in the exhaust corridor 640. In an embodiment, where the gas that flows in the exhaust corridor 640 is exhaust gas from an internal combustion engine, the gas corridor 642 channels a bleed stream 650 that is taken from the larger exhaust stream 648 within the exhaust corridor 640.

In an embodiment, the gas corridor 642 is coupled with a cooling-stream corridor 644. In order to protect the particle array 601 from excessive conditions, the cooling-stream corridor 644 allows a cooling gas 646 to mix with the bleed stream 650 such that analysis of the bleed stream 650 may be done without damaging the particle array 601. In an embodiment, the bleed stream 650 is monitored and the cooling gas 646 is added at a temperature and flow volume that forms a pre-mix gas 652 at a temperature just above the dew point. This allows the pre-mix gas 652 to condense in part upon the particle array 601, particularly upon exposed portions of the Raman-active film 624, without materially changing temperature and pressure conditions for the particle array 601.

In a method embodiment, a cooling gas 646 is mixed with a bleed stream 650, and the pre-mix gas 652 condenses in part upon the particle array 601. In an embodiment, a light source 654 projects coherent (laser) light onto the particle array 601, and Raman-scattered light is detected at a light receptor 656. The light that is detected at the receptor light 656 may be compared to the light that was projected from the light source 654. In an embodiment, where a known gas is passing over the particle array 601, a lookup table may be used for known Raman-active scattered light for known systems. For example in a diesel engine, fuel impurities may be detected in the pre-mix gas 652 based upon standardized tests that are recorded in a database. In an embodiment where the gas is other than an exhaust gas, impurities or anomalies may be detected in the pre-mix gas 652 based upon standardized tests that are recorded in a database.

Although the apparatus is depicted with a bleed stream 650 to cool the gas, the bleed stream may be heat exchanged instead of mixed with the cooling gas 646; the cooling gas may simply pass through an exchanger instead of mixing directly with the bleed stream 650.

In an embodiment, the apparatus needs no cooling-stream mix or nor heat exchanger, as a selected gas that is susceptible to Raman-scattering analysis may impinge the particle array 601 at temperatures and flow rates that are not damaging to the particle array 601.

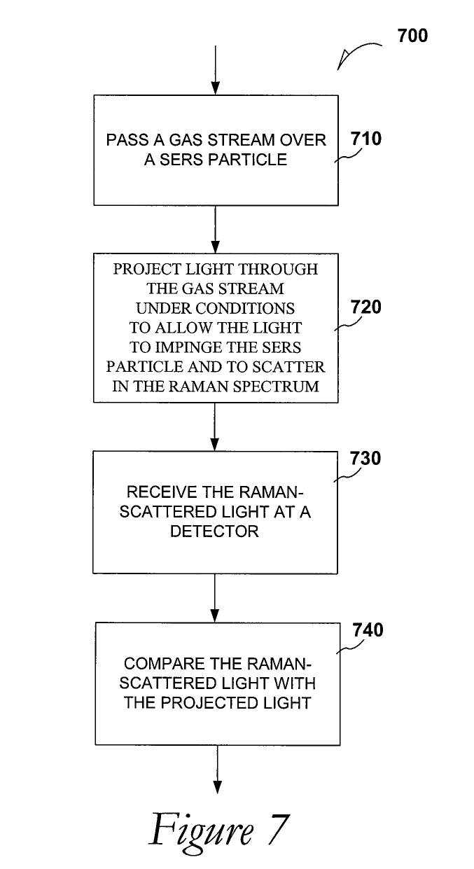

FIG. 7 represents a method 700 of analyzing a gas stream.

At 710 the method includes passing a gas stream over a surface-enhanced Raman scattering (SERS) particle.

At 720, the method includes projecting light through the gas stream under conditions to allow the light to impinge the SERS particle and to scatter in the Raman spectrum. In an embodiment, the light is single frequency coherent (laser) light. Consequently, the coherent light is scattered under Raman scattering conditions.

At 730, the method includes receiving the Raman-scattered light at a detector.

At 740, the method includes comparing the scattered light with the projected light.

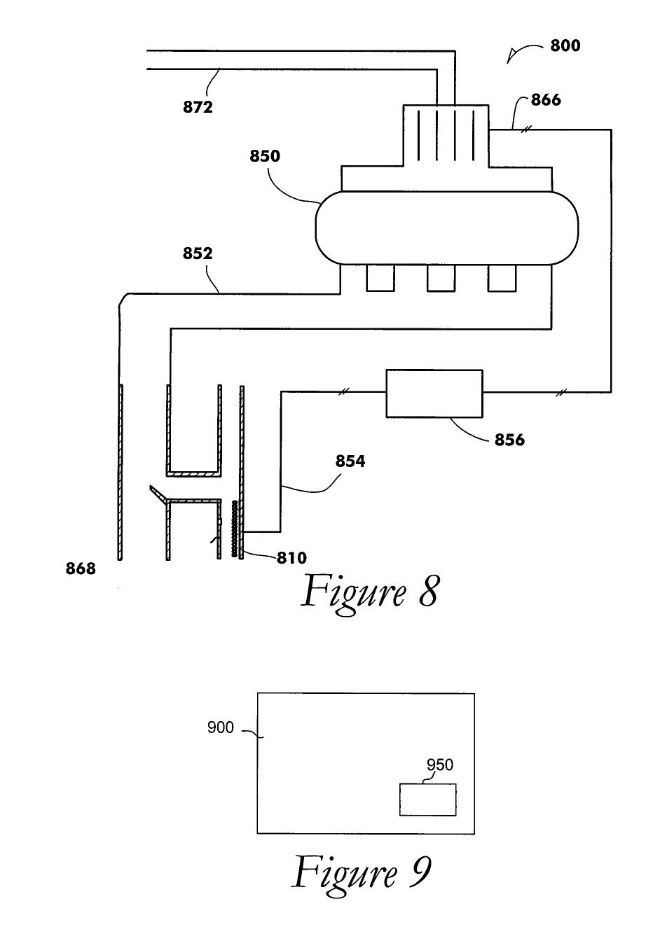

FIG. 8 is one version of a loop 800 for engine control based on gas stream analysis that uses the passing of a gas stream over a SERS particle according to an embodiment. After a gas stream passes through an engine intake 872 and is combined with combustion materials, an engine 850 may output an exhaust 852 which is sensed by a SERS apparatus 810, which in turn may output a signal 854 to a processor 856.

The output from the processor 856 may include an electronic indication of the qualities in the exhaust gas stream that can be correlated to known peculiarities in a gas stream for process control reasons. This electronic indication may go to an output signal 866 which may be correlated with other various inputs of engine data. Examples of various inputs include timing, temperature, percent exhaust-gas recirculation (EGR), valve position, and others.

It can now be appreciated that several and complex combinations of engine performance can be monitored in part at least by use of a SERS particle apparatus embodiment set forth in this disclosure.

FIG. 9 is a schematic diagram illustrating a medium having an instruction set, according to an example embodiment that uses a SERS particle apparatus. A machine-readable medium 900 includes any type of medium such as a link to the Internet or other network, or a disk drive or a solid state memory device, or the like. A machine-readable medium 900 includes instructions within an instruction set 950. The instructions, when executed by a machine such as an information handling system or a processor, cause the machine to perform operations that include charachterization of gas stream embodiments.

In an example embodiment of a machine-readable medium 900 that includes a set of instructions 950, the instructions, when executed by a machine, cause the machine to perform operations including gas stream analysis that use a SERS particle apparatus embodiment. In an embodiment, the machine-readable medium 900 and instructions 950 are disposed in a module and are locatable within the engine compartment of the internal combustion engine such as a diesel tractor. In an embodiment, the machine-readable medium 900 and instructions 950 are disposed in a module and are locatable within the cab, such as near the firewall of the engine compartment of an internal combustion engine such as a diesel tractor.

Thus, a system, method, and machine-readable medium including instructions for Input/Output scheduling have been described. Although the various calibration, in situ recalibration, and methods have been described with reference to specific example embodiments, it will be evident that various modifications and changes may be made to these embodiments without departing from the broader scope of the disclosed subject matter. Accordingly, the specification and drawings are to be regarded in an illustrative rather that a restrictive sense.

What is claimed is:

1. A process comprising:
bonding a selectively and asymmetrically coated particle to a mounting substrate, wherein the selectively and asymmetrically coated particle includes a shell first location and a shell second location, wherein the asymmetrically coated particle is bonded to the mounting substrate at the shell first location, and wherein the shell second location includes a Raman-active film.

2. The process of claim 1, wherein bonding the selectively and asymmetrically coated particle to the mounting substrate includes bonding onto a metallic film that is disposed on the mounting substrate.

3. The process of claim 1, wherein bonding the selectively and asymmetrically coated particle to the mounting substrate includes bonding onto a metallic film that is disposed on the mounting substrate, and wherein bonding further includes bonding acceptor molecules on the coated particle to receptor molecules on the metallic film.

4. The process of claim 1, wherein bonding is preceded by:
selectively treating the asymmetrically coated particle at the first location with a substrate-acceptor molecule; and
selectively coating the asymmetrically coated particle at the second location with the Raman-active film.

5. The process of claim 1, wherein bonding the selectively and asymmetrically coated particle to the mounting substrate includes bonding onto a metallic film that is disposed on the mounting substrate wherein bonding is preceded by:
selectively treating the asymmetrically coated particle at the first location with a substrate-acceptor molecule;
selectively coating the asymmetrically coated particle at the second location with the Raman-active film; and
forming a substrate-receptor molecule on the metallic film.

6. An article comprising:
a core including a core diameter in a range from about 10 nanometer (nm) to about 1,000 nm;
an asymmetrical optical coating in contact with and covering the core; and
a surface-enhanced Raman scattering (SERS) film disposed upon a portion of the asymmetrical optical coating.

7. The article of claim 6, further including a mounting substrate upon which the core is disposed wherein the SERS film is oriented away from the mounting substrate.

8. The article of claim 6, further including:
a mounting substrate upon which the core is disposed wherein the SERS film is oriented away from the mounting substrate, wherein the core is one of a plurality of cores, each with an asymmetrical optical coating in contact with and covering the core, and each with a SERS film disposed upon a portion of the asymmetrical optical coating.

9. An apparatus comprising:
a core, wherein the core has a diameter in the range from about 1 nanometer (nm);
an asymmetrical optical coating in contact with and covering the core;
a surface-enhanced Raman scattering (SERS) film disposed upon a portion of the asymmetrical optical coating an asymmetrical metallic shell disposed on the core, wherein the core, the asymmetrical optical coating, and the SERS film form a particle;
a mounting substrate upon which the particle is mounted; and
a gas corridor in which the mounting substrate is disposed.

10. The apparatus of claim 9, wherein the gas corridor is to channel a bleed stream from an exhaust corridor of an internal combustion engine.

11. The apparatus of claim 9, wherein the gas corridor is to channel a bleed stream from an exhaust corridor of an internal combustion engine; and further including:
a light source to project light onto the particle at the SERS film; and
a light receptor to detect Raman-active reflections from the light source.

12. The apparatus of claim 11, further including:
a diagnostic machine coupled to the light receptor, wherein the diagnostic machine includes capability to match detected light with a database for Raman-active materials.

13. The apparatus of claim 11, further including:
a diagnostic machine coupled to the light receptor, wherein the diagnostic machine includes capability to match detected light with a database for Raman-active materials; and a machine-readable medium that contains instructions to carry out a method of detecting materials in the bleed stream.

14. The apparatus of claim 13, wherein the machine-readable medium is couplable to an internal combustion engine.

15. The apparatus of claim 9, wherein the gas corridor is to channel a bleed stream from an exhaust corridor of an internal combustion engine, and wherein the bleed stream is couplable with a mixer feed to cool a gas in the bleed stream.

16. The apparatus of claim 9, wherein the gas corridor is to channel a bleed stream from an exhaust corridor of an internal combustion engine, and wherein the bleed stream is interfaced with a heat exchanger to cool gas that passes through the bleed stream.

17. A method comprising:
passing a gas stream over a surface-enhanced Raman scattering (SERS) particle;
projecting light through the gas stream under conditions to allow the light to impinge the SERS particle and to scatter in the Raman spectrum; and
receiving the Raman-scattered light at a detector.

18. The method of claim 17, further including comparing the scattered light with the projected light; and

19. The method of claim 17, further including:
comparing the shattered light with the projected light: and
adjusting conditions of an internal combustion engine that is coupled to the detector.

20. The method of claim 17, wherein projecting light through the gas stream is preceded by cooling the gas stream.
